(19) United States
(12) Patent Application Publication
(10) Pub. No.: US 2019/0105670 A1
(43) Pub. Date: Apr. 11, 2019

(54) COATING DEVICE AND COATING METHOD

(71) Applicant: HONDA MOTOR CO., LTD., MINATO-KU, TOKYO (JP)

(72) Inventors: Keiki HAYASHI, HAGAGUN, TOCHIGI (JP); Masaaki SHOJI, HAGAGUN, TOCHIGI (JP); Noboru KAMISHINA, HAGAGUN, TOCHIGI (JP); Hirosato MARUYAMA, HAGAGUN, TOCHIGI (JP)

(21) Appl. No.: 16/087,476

(22) PCT Filed: Mar. 27, 2017
(86) PCT No.: PCT/JP2017/012287

§ 371 Date: Sep. 21, 2018

(30) Foreign Application Priority Data
Mar. 28, 2016 (JP) 2016-064326

(51) Int. Cl. B05B 5/16; B05D 1/04

(52) U.S. Cl. CPC B05B 5/16; B05D 1/04

(57) ABSTRACT

An electrostatic coating device includes a rotary atomizing head, a first supply pipe for supplying a main agent, a second supply pipe for supplying a curing agent, a first mixing part for merging the first supply pipe and the and second supply pipes and causing the main and curing agents to mix, and a liquid mixture supply pipe for supplying a mixed liquid agent to the rotary atomizing head. The first mixing part is provided with: an outer pipe part connected to the second supply pipe and formed so as to surround the external periphery of a distal-end part of the first supply pipe; and a merging part for merging the main and curing agents so that the curing agent surrounds the external periphery of the main agent supplied from the first supply pipe, the merging part being formed in the vicinity of the distal-end part of the first supply pipe.

### TECHNICAL FIELD

The present invention relates to a coating device and a coating method capable of performing a coating of a mixed liquid agent having a plurality of liquid agents mixed therein.

### BACKGROUND ART

Conventionally, as a coating device of coating a coating target such as a vehicle body, for example, a coating device that mixes and sprays a main agent and a curing agent is known. In such a coating device, the main agent and the curing agent are supplied into a cup-shaped rotary atomizing head rotating at a high speed by an air motor or the like and are sprayed while being mixed and atomized.

Here, for example, a coating device that collects a main agent and a curing agent at a collection part and coats a liquid mixture is proposed (for example, see Patent Document

Patent Document 1: Japanese Patent No. 4015922

### DISCLOSURE OF THE INVENTION

### Problems to be Solved by the Invention

However, in the coating device disclosed in Patent Document 1, the mixing of the main agent and the curing agent was performed only at the inner surface side of the rotary atomizing head. For example, when the viscosity of the main agent is high, there is a case in which the main agent and the curing agent are not sufficiently mixed. In this case, there is a case in which the main agent to be used in the coating device is limited by the viscosity.

An object of the invention is to provide a coating device for performing a coating by a liquid mixture including at least a first liquid agent and a second liquid agent and improving mixing properties of the first liquid agent and the second liquid agent. Further, an object of the invention is to provide a coating method of performing a coating by a liquid mixture including at least a first liquid agent and a second liquid agent and improving mixing properties of the first liquid agent and the second liquid agent.

### Means for Solving the Problems

A coating device (for example, an electrostatic coating device 1) of the invention includes: a rotary atomizing head (for example, a rotary atomizing head 22) which rotates while being applied with a high voltage to charge and atomize a mixed liquid agent (for example, paint P) including at least a first liquid agent (for example, a main agent L1) and a second liquid agent (for example, a curing agent L2); a first supply pipe (for example, a first supply pipe 130) which supplies the first liquid agent; a second supply pipe (for example, a second supply pipe 140) which supplies the second liquid agent; a mixing part (for example, a first mixing part 150) which merges the first supply pipe with the second supply pipe and causes the first liquid agent and the second liquid agent to be mixed; and a liquid mixture supply pipe (for example, a liquid mixture supply pipe 160) which is disposed between the mixing part and the rotary atomizing head and supplies the mixed liquid agent to the rotary atomizing head. Then, the mixing part includes an outer pipe part (for example, an outer pipe part 151) which is formed to surround an outer periphery of an end part (for example, a distal-end part 130a) on the side of the liquid mixture supply pipe of the first supply pipe and is connected to the second supply pipe and a merging part 152 which is formed in the vicinity of the end part of the first supply pipe and merges the first liquid agent with the second liquid agent so that the second liquid agent supplied from the outer pipe part surrounds the outer periphery of the first liquid agent supplied from the first supply pipe.

According to the coating device of the invention, since the mixing of the first liquid agent and the second liquid agent to be supplied to the rotary atomizing head can be promoted, the mixing properties of the first liquid agent and the second liquid agent can be improved. Further, since a contact surface between the first liquid agent and the second liquid agent in the mixed liquid agent can be set to be large (a length of a contact part in a cross-section can be set to be long), the mixing properties of the first liquid agent and the second liquid agent can be further improved. Further, since the mixing properties are improved, a high-viscosity liquid agent can be used. Accordingly, the coping ability of the coating device can be improved.

Further, the coating device (for example, the electrostatic coating device 1) of the invention further includes a mixing member (for example, a mixing member 165) that is disposed inside the liquid mixture supply pipe (for example, the liquid mixture supply pipe 160), includes a plurality of torsion elements, and further mixes the mixed liquid agent (for example, the paint P) flowing in the liquid mixture supply pipe.

According to the coating device of the invention, since the mixed liquid agent of which a contact surface between the first liquid agent and the second liquid agent increases (a length of a contact part in a cross-section increases) is further mixed (stirred) by the mixing member, the mixing properties can be further improved. Further, since the mixed liquid agent of which a contact surface between the first liquid agent and the second liquid agent increases (a length of a contact part in a cross-section increases) is further mixed (stirred) by the mixing member (the mixing member 165), the length of the mixing member can be shortened (the number of elements can be decreased) while maintaining predetermined mixing properties. For example, compared to a case in which the mixing part (the first mixing part) is not used, the length of the mixing member (the number of elements) can be shortened (decreased) by about 50%. Accordingly, since the length of the mixing member (the number of elements) can be shortened (decreased) by about 50%, the coating device can be decreased in size. Further, since the length of the mixing member (the number of elements) can be shortened (decreased) by about 25%, the coating device can improve the internal cleaning performance.

Further, a coating method of the invention includes: a first supply step of supplying a first liquid agent (for example, a main agent L1); a second supply step of supplying a second liquid agent (for example, a curing agent L2); a first mixing step corresponding to a mixing step of mixing the first liquid agent and the second liquid agent so that the second liquid agent surrounds the outer periphery of the first liquid agent to be merged with the first liquid agent; a liquid mixture supply step of supplying a mixed liquid agent obtained by the first mixing step to a rotary atomizing head (for example, a rotary atomizing head 22); and a rotary atomization step of charging and atomizing the mixed liquid agent by the rotary atomizing head.

According to the coating method of the invention, since the mixing of the first liquid agent and the second liquid agent to be supplied to the rotary atomizing head can be promoted, the mixing properties of the first liquid agent and the second liquid agent can be improved. Further, since a contact surface between the first liquid agent and the second liquid agent in the mixed liquid agent is set to be large (a length of a contact part in a cross-section is set to be long), the mixing properties of the first liquid agent and the second liquid agent can be improved.

Further, in the invention, the liquid mixture supply step further includes a second mixing step of further mixing the mixed liquid agent (for example, the paint P) by the mixing member (for example, the mixing member 165) including the plurality of torsion elements.

In the coating method of the invention, since the mixed liquid agent of which a contact surface between the first liquid agent and the second liquid agent increases (a length of a contact part in a cross-section increases) is further mixed (stirred) by the mixing member, the mixing properties can be further improved. Further, since the mixed liquid agent (the paint P) of which a contact surface between the first liquid agent and the second liquid agent increases (a length of a contact part in a cross-section increases) is further mixed (stirred) by the mixing member, the length of the mixing member can be shortened (the number of elements can be decreased) while maintaining predetermined mixing properties. For example, compared to a case in which the mixing part (the first mixing part) is not used, for example, the length of the mixing member (the number of elements) can be shortened (decreased) by about 25%. Accordingly, since the length of the mixing member (the number of elements) can be shortened (decreased) by about 25%, the coating method can decrease the size of the coating device in use. Further, since the length of the mixing member (the number of elements) can be shortened (decreased) by about 25%, the internal cleaning performance of the coating device in use can be improved.

### Effects of the Invention

According to the invention, it is possible to provide a coating device for performing a coating by a liquid mixture including at least a first liquid agent and a second liquid agent and improving mixing properties of the first liquid agent and the second liquid agent. Further, according to the invention, it is possible to provide a coating method of performing a coating by a liquid mixture including at least a first liquid agent and a second liquid agent and improving mixing properties of the first liquid agent and the second liquid agent.

### BRIEF DESCRIPTION OF THE DRAWINGS

FIG. 1 is a side view of an electrostatic coating device according to an embodiment.

FIG. 2 is a cross-sectional view illustrating a configuration of a distal-end part of the electrostatic coating device according to the embodiment.

FIG. 3 is a cross-sectional view illustrating the configuration of the distal-end part of the electrostatic coating device according to the embodiment and is a cross-sectional view taken along a line A-A of FIG. 2.

FIG. 4 is an enlarged view of a supply pipe of FIG. 2.

FIG. 5 is an enlarged view of the supply pipe of FIG. 3.

FIG. 6 is an enlarged cross-sectional view describing a configuration of a first mixing part.

FIG. 7 is a cross-sectional view taken along a line B-B of FIG. 6.

FIG. 8 is a cross-sectional view describing a configuration of a liquid mixture supply pipe.

FIG. 9 is a perspective view of a mixing member.

FIGS. 10A and 10B are a schematic diagram describing a mixing of a first liquid agent and a second liquid agent and is a schematic diagram describing a relationship between the first liquid agent and the second liquid agent on the upstream side of the first mixing part.

FIG. 11 is a schematic diagram describing a mixing of the first liquid agent and the second liquid agent and is a schematic diagram describing a relationship between the first liquid agent and the second liquid agent in the first mixing part.

FIG. 12 is a schematic diagram describing a mixing of the first liquid agent and the second liquid agent and is a schematic diagram describing a relationship between the first liquid agent and the second liquid agent merged at the first mixing part.

FIG. 13 is a schematic diagram describing a mixing of the first liquid agent and the second liquid agent and is a schematic diagram illustrating a mixed state in a second mixing part.

### PREFERRED MODE FOR CARRYING OUT THE INVENTION

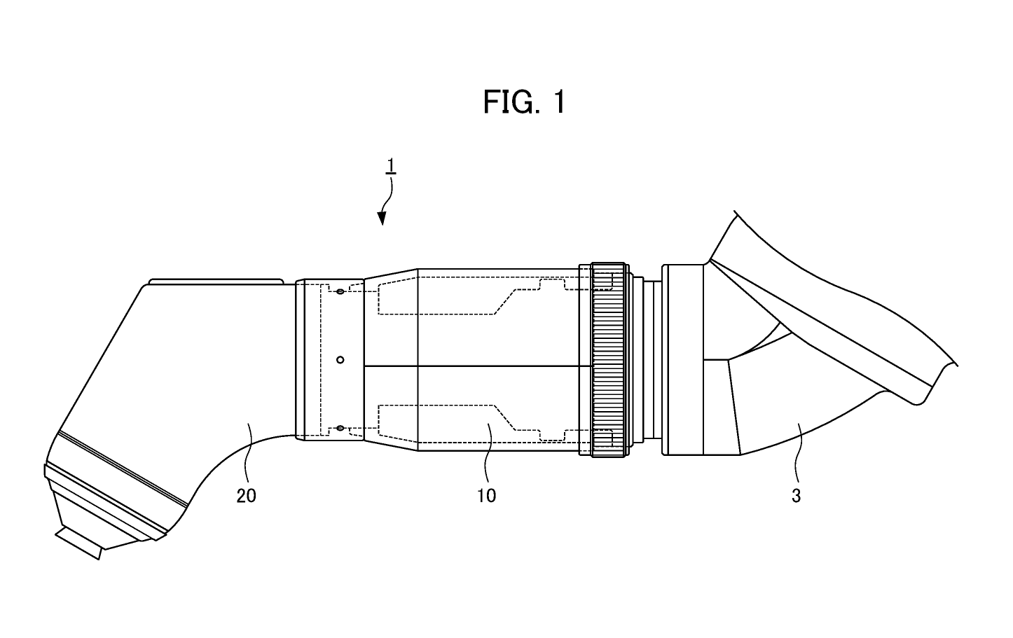

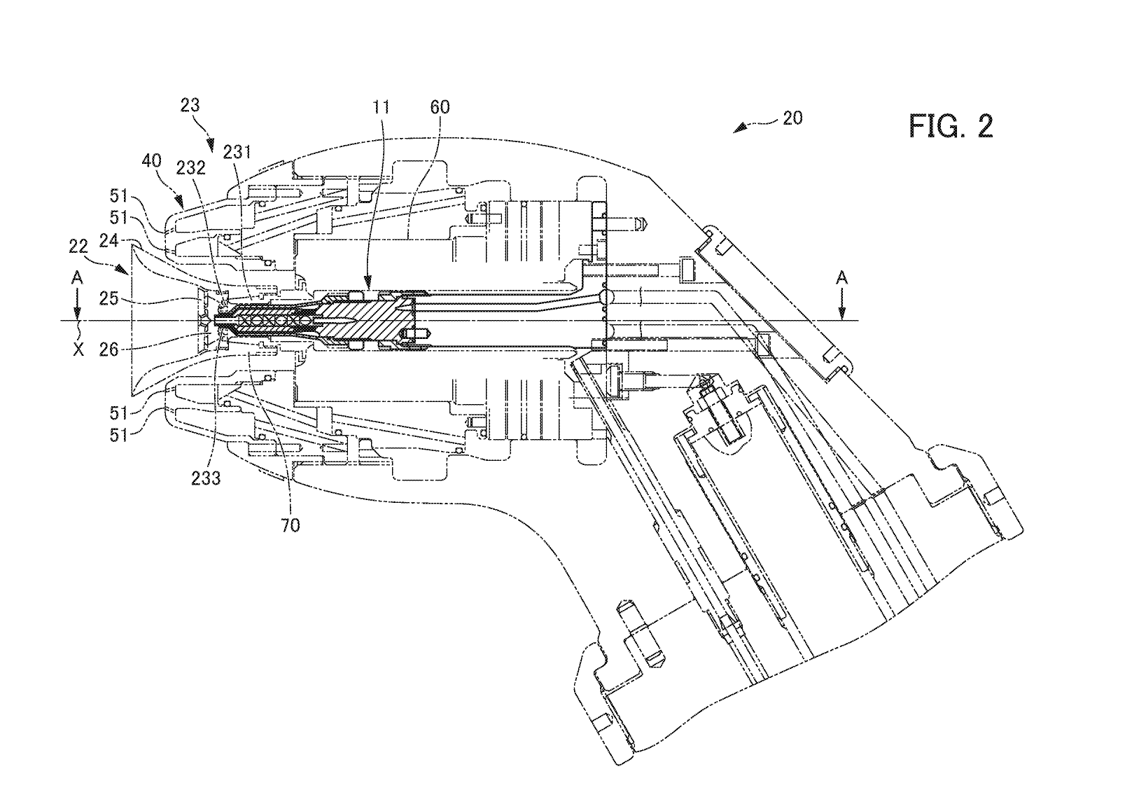

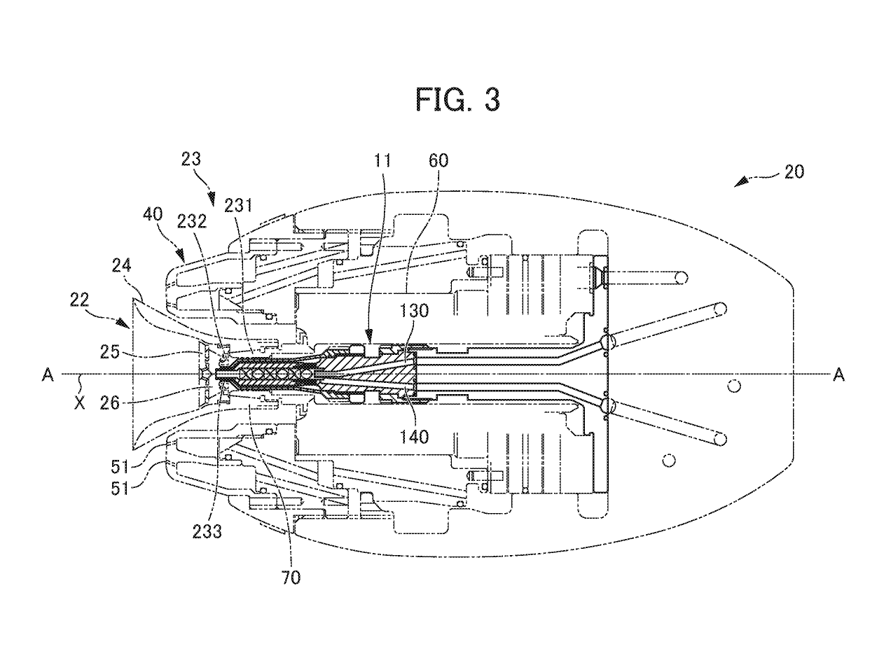

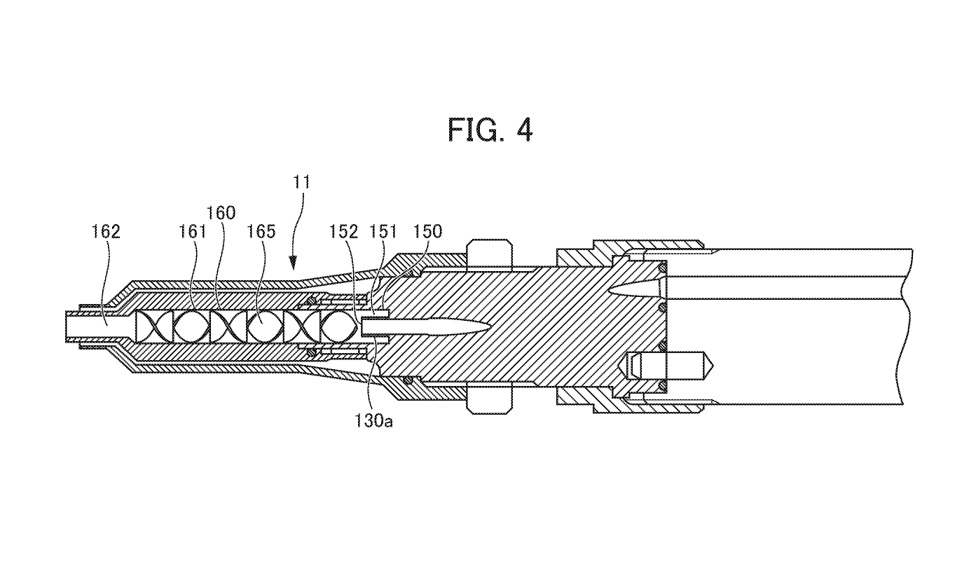

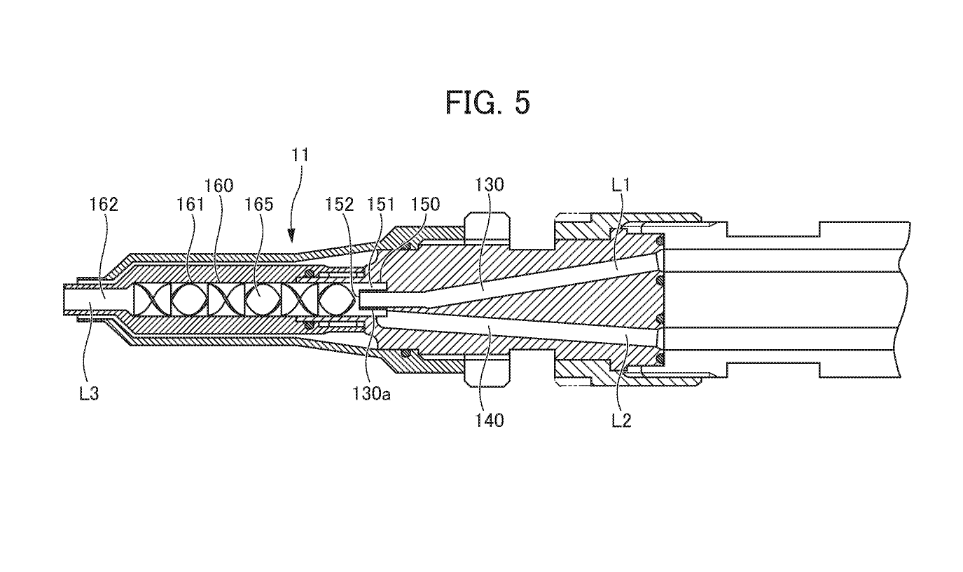

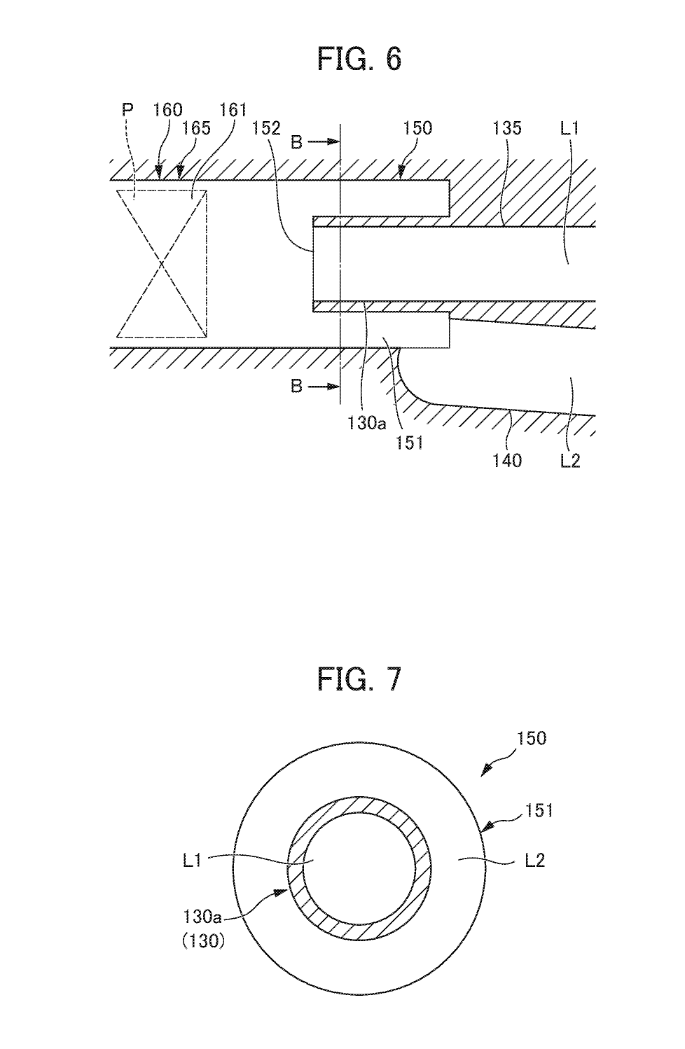

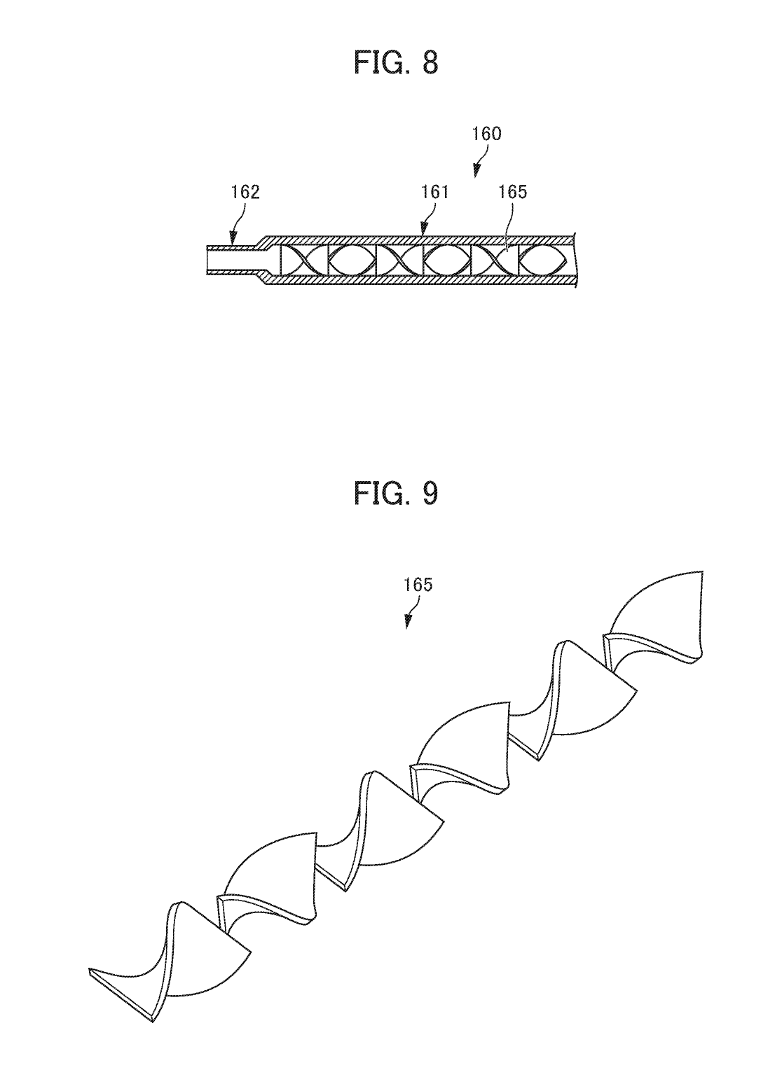

Hereinafter, an embodiment of the invention will be described in detail with reference to FIGS. 1 to 13. Above all, a configuration of an electrostatic coating device 1 (a coating device) according to this embodiment will be described with reference to FIGS. 1 to 9. FIG. 1 is a side view of an electrostatic coating device according to an embodiment. FIG. 2 is a cross-sectional view illustrating a configuration of a distal-end part of the electrostatic coating device according to the embodiment. FIG. 3 is a cross-sectional view illustrating the configuration of the distal-end part of the electrostatic coating device according to the embodiment and is a cross-sectional view taken along a line A-A of FIG. 2. FIG. 4 is an enlarged view of a supply pipe of FIG. 2. FIG. 5 is an enlarged view of the supply pipe of FIG. 3. FIG. 6 is an enlarged cross-sectional view describing a configuration of a first mixing part. FIG. 7 is a cross-sectional view taken along a line B-B of FIG. 6. FIG. 8 is a cross-sectional view describing a configuration of a liquid mixture supply pipe. FIG. 9 is a perspective view of a mixing member.

As illustrated in FIGS. 1 and 2, the electrostatic coating device 1 (the coating device) is used to electrostatically coat a body or the like of an automobile or a motorcycle. The electrostatic coating device 1 includes a columnar body part 10 which is attached to a distal end of a robot arm 3 and a head part 20 which is formed in a substantially L-shape by bending a distal-end part and is removably attached to a distal end of the body part 10.

As illustrated in FIGS. 2 and 3, the head part 20 includes an air motor 60, a rotary atomizing head 22 which is rotationally driven by the air motor 60, a supply pipe 11 which supplies a paint (a mixed liquid agent) to the rotary atomizing head 22, an air cap 40 which surrounds the rotary atomizing head 22, and a high voltage generator 70 which applies a high voltage to the rotary atomizing head 22 to charge a paint with the high voltage.

The rotary atomizing head 22 is formed in a substantially conical shape of which an inner diameter increases toward a distal end and is provided at a distal end of the head part 20. The rotary atomizing head 22 is provided to be rotatable about a rotation axis X which is a rotation axis.

The rotary atomizing head 22 includes a cylindrical rotary part 23 which accommodates the supply pipe 11 therein, an expanded part 24 which is provided at a distal end of the rotary part 23 and is provided to surround a distal end of the supply pipe 11 and to be expanded in a spraying direction, and a substantially disc-shaped blocking part 25 which is provided at the distal end side of the supply pipe 11 and blocks an inner wall surface of the expanded part 24.

The rotary part 23 includes a cylindrical rotary part body 231 and a substantially disc-shaped distal-end part 232 which blocks a distal end of the rotary part body 231. The expanded part 24 is threaded into the rotary part 23. A substantial center of the distal-end part 232 is provided with a through-hole 233 through which a nozzle part 162 of a liquid mixture supply pipe 160 of the supply pipe 11 is inserted. The supply pipe 11 is inserted through the rotary part 23. A distal end of the supply pipe 11 (an end part on the side of the rotary atomizing head) is disposed to be inserted through the through-hole 233 of the distal-end part 232. Further, a space which is blocked by the inner wall surface of the expanded part 24 and the blocking part 25 becomes an atomization chamber 26 which applies a centrifugal force to paint.

Plural air ejection holes 51 which are formed to surround the rotary atomizing head 22 are formed at a distal-end part of the air cap 40 at the same intervals in the circumferential direction about the rotation axis X. In this embodiment, the plural air ejection holes 51 are formed on two concentric circles about the rotation axis X. Shaping air which is ejected from the plural air ejection holes 51 collides with the paint sprayed from a distal-end edge due to the centrifugal force of the rotary atomizing head 22 to promote the atomization of the paint and to direct the paint spraying direction to the center.

As illustrated in FIGS. 2 to 5, the supply pipe 11 includes a first supply pipe 130, a second supply pipe 140, a first mixing part 150, and a liquid mixture supply pipe 160.

In this embodiment, the first supply pipe 130 supplies a main agent L1 (a first liquid agent). The first supply pipe 130 is a supply pipe through which the main agent L1 passes from a main agent supply source (not illustrated) to the rotary atomizing head 22. The first supply pipe 130 includes a distal-end part 130a which is an end-side part on the side of the liquid mixture supply pipe 160. The distal-end part 130a is disposed inside an outer pipe part 151 to be described later in the first mixing part 150.

In this embodiment, the second supply pipe 140 supplies a curing agent L2 (a second liquid agent). The second supply pipe 140 is a supply pipe through which the curing agent L2 passes from a curing agent supply source (not illustrated) to the rotary atomizing head 22. The second supply pipe 140 is connected to the first mixing part 150 so that the curing agent L2 can be supplied to the outer pipe part 151 to be described later.

As illustrated in FIGS. 5 to 7, the first mixing part 150 is a part that merges the first supply pipe 130 with the second supply pipe 140 and causes the main agent L1 and the curing agent L2 to be mixed. The first mixing part 150 includes an outer pipe part 151 and a merging part 152.

The outer pipe part 151 is formed to surround an outer periphery of the distal-end part 130a which is an end-side part on the side of the liquid mixture supply pipe 160 of the first supply pipe 130. Further, the outer pipe part 151 is connected to the second supply pipe 140. The outer pipe part 151 is disposed in a ring shape to surround the outer periphery of the distal-end part 130a of the first supply pipe 130. The outer pipe part 151 forms a double pipe structure along with the distal-end part 130a. In the outer pipe part 151, the curing agent L2 is disposed in a ring shape at the outside of the main agent L1.

The merging part 152 is formed in the vicinity of the distal-end part 130a in the first supply pipe 130 and merges the main agent L1 and the curing agent L2 so that the curing agent L2 supplied from the outer pipe part 151 surrounds the outer periphery of the main agent L1 supplied from the first supply pipe 130. In the merging part 152, the curing agent L2 which flows while being disposed in a ring shape merges with the main agent L1 to surround the outer periphery thereof. In the merging part 152, the main agent L1 and the curing agent L2 are mixed. The merging part 152 mixes the main agent L1 and the curing agent L2 so that a contact surface increases (so that a length of a contact part in a cross-section increases).

As illustrated in FIGS. 5 and 6, the liquid mixture supply pipe 160 is disposed between the first mixing part 150 and the rotary atomizing head 22. The liquid mixture supply pipe 160 supplies the paint P (the mixed liquid agent) obtained by the mixing at the first mixing part 150 to the rotary atomizing head 22. The liquid mixture supply pipe 160 includes a second mixing part 161 and a nozzle part 162.

As illustrated in FIGS. 8 and 9, a mixing member 165 is disposed in the second mixing part 161. The mixing member 165 is disposed inside the second mixing part 161 (the liquid mixture supply pipe 160). The mixed liquid agent of the main agent L1 and the curing agent L2 obtained by the mixing in the first mixing part 150 and passing through the second mixing part 161 is further mixed by the mixing member 165 disposed therein.

The mixing member 165 is a member that includes a plurality of torsion elements. The mixing member 165 is disposed inside a part corresponding to the second mixing part 161 inside the liquid mixture supply pipe 160. The mixing member 165 is a member that further mixes the mixed liquid agent (the paint P) of the main agent L1 and the curing agent L2 passing through the liquid mixture supply pipe 160. The mixing member 165 mixes (stirs) a mixed liquid by interrupting and guiding the flow of the mixed liquid agent (the paint P) of the main agent L1 and the curing agent L2 flowing in the liquid mixture supply pipe 160 using the elements. In this embodiment, since a contact surface between the main agent L1 and the curing agent L2 increases (a length of a contact part in a cross-section increases) in the liquid mixture supplied to the second mixing part 161, the liquid mixture passing through the second mixing part 161 is further mixed.

The nozzle part 162 is disposed on the side of the rotary atomizing head 22 in the liquid mixture supply pipe 160 and supplies the paint P (the liquid mixture) to the rotary atomizing head 22. In this embodiment, the main agent L1 and the curing agent L2 are appropriately mixed in the first mixing part 150 and the second mixing part 161. For that reason, the nozzle part 162 supplies the paint P in which the main agent L1 and the curing agent L2 are appropriately mixed to the rotary atomizing head 22.

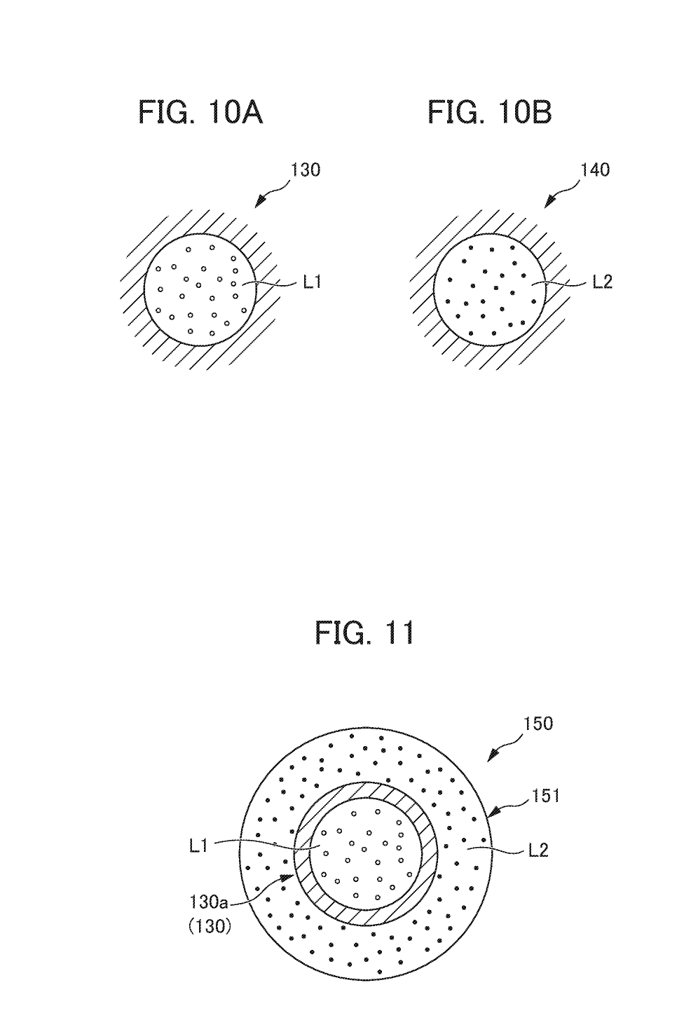

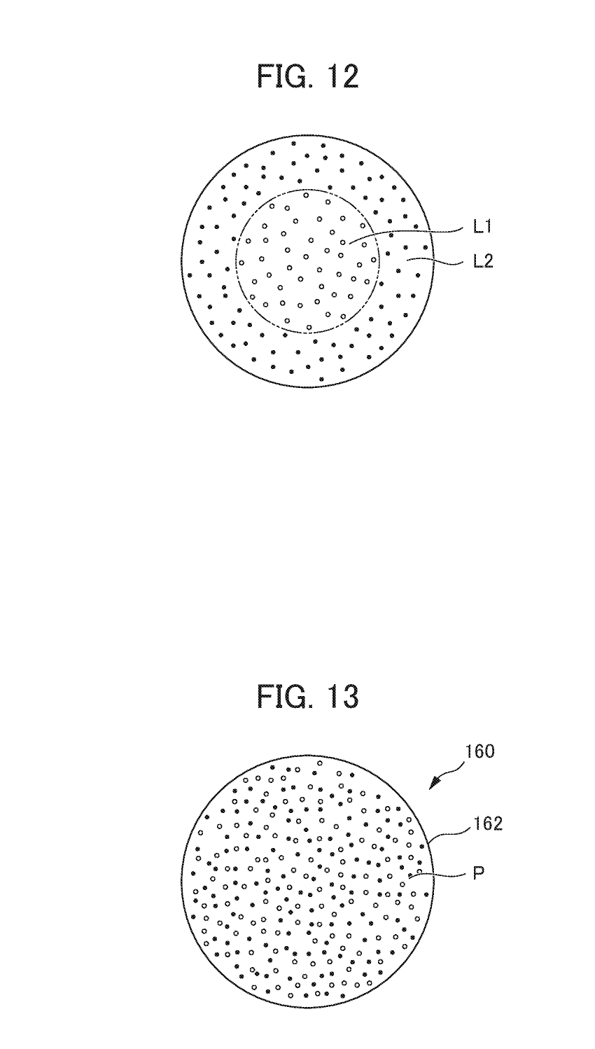

With reference to FIGS. 10 to 13, an operation of the electrostatic coating device 1 of this embodiment will be described. FIGS. 10A and 10B are a schematic diagram describing a mixing of a first liquid agent and a second liquid agent and is a schematic diagram describing a relationship between the first liquid agent and the second liquid agent on the upstream side of the first mixing part. FIG. 11 is a schematic diagram describing a mixing of the first liquid agent and the second liquid agent and is a schematic diagram describing a relationship between the first liquid agent and the second liquid agent in the first mixing part. FIG. 12 is a schematic diagram describing a mixing of the first liquid agent and the second liquid agent and is a schematic diagram describing a relationship between the first liquid agent and the second liquid agent merged at the first mixing part. FIG. 13 is a schematic diagram describing a mixing of the first liquid agent and the second liquid agent and is a schematic diagram illustrating a mixed state in a second mixing part.

Above all, as illustrated in FIGS. 10A and 10B, the main agent L1 (the first liquid agent) on the upstream side of the first mixing part 150 is supplied to the rotary atomizing head 22 side by the first supply pipe 130 (a first supply step). Further, the curing agent L2 (the second liquid agent) is supplied to the rotary atomizing head 22 side by the second supply pipe 140 (a second supply step). The main agent L1 and the curing agent L2 are respectively supplied by separate supply pipes.

Next, as illustrated in FIG. 11, the first supply pipe 130 supplies the main agent L1 from a main agent supply source (not illustrated) to the first mixing part 150. Further, the second supply pipe 140 supplies the curing agent L2 from a curing agent supply source (not illustrated) to the first mixing part 150. Then, first, the curing agent L2 in the first mixing part 150 is supplied from the second supply pipe 140 to the outer pipe part 151. Accordingly, the curing agent L2 passing through the outer pipe part 151 is disposed (to flow) in a ring shape at the outside of the main agent L1.

Next, as illustrated in FIG. 12, the main agent L1 and the curing agent L2 are merged in the merging part 152 formed in the vicinity of the distal-end part 130a of the first supply pipe 130 so that the curing agent L2 supplied from the outer pipe part 151 surrounds the outer periphery of the main agent L1 supplied from the first supply pipe 130 (a mixing step). In the merging part 152, the curing agent L2 which is disposed to flow in a ring shape is merged with the main agent L1 to surround the outer periphery of the main agent. In the merging part 152, the main agent L1 and the curing agent L2 are mixed so that a contact surface increases (a length of a contact part in a cross-section increases).

Next, as illustrated in FIG. 13, the main agent L1 and the curing agent L2 contacting each other in the first mixing part 150 pass through the liquid mixture supply pipe 160. First, the mixed liquid agent is further mixed by the mixing member 165 disposed inside the second mixing part 161 of the liquid mixture supply pipe 160 (a second mixing step (a liquid mixture supply step)). Since a contact surface between the main agent L1 and the curing agent L2 increases (a length of a contact part in a cross-section increases), the liquid mixture supplied to the second mixing part 161 is mixed so that the liquid mixture passing through the second mixing part 161 becomes further uniform.

Next, the paint P which is the mixed liquid agent further mixed by the mixing member 165 is supplied to the rotary atomizing head 22 by the liquid mixture supply pipe 160 (a liquid mixture supply step). The paint P is supplied from the nozzle part 162 of the liquid mixture supply pipe 160 to the rotary atomizing head 22.

Then, the paint P which is supplied by the nozzle part 162 is charged and atomized by the rotary atomizing head 22 so that a coating target is coated (a rotary atomization step).

According to the electrostatic coating device 1 of this embodiment, the following effect is obtained. The coating device (the electrostatic coating device 1) of this embodiment includes: the rotary atomizing head (the rotary atomizing head 22) which rotates while being applied with a high voltage to charge and atomize a mixed liquid agent (the paint P) including at least the first liquid agent (the main agent L1) and the second liquid agent (the curing agent L2); the first supply pipe (the first supply pipe 130) which supplies the first liquid agent; the second supply pipe (the second supply pipe 140) which supplies the second liquid agent; the mixing part (the first mixing part 150) which merges the first supply pipe with the second supply pipe and causes the first liquid agent and the second liquid agent to be mixed with each other; and the liquid mixture supply pipe (the liquid mixture supply pipe 160) which is disposed between the mixing part and the rotary atomizing head and supplies the mixed liquid agent to the rotary atomizing head. Then, the mixing part includes the outer pipe part (the outer pipe part 151) which is formed to surround the outer periphery of the end part (the distal-end part 130a) on the side of the liquid mixture supply pipe of the first supply pipe and is connected to the second supply pipe and the merging part 152 which is formed in the vicinity of the end part of the first supply pipe and merges the first liquid agent with the second liquid agent so that the second liquid agent supplied from the outer pipe part surrounds the outer periphery of the first liquid agent supplied from the first supply pipe.

According to the coating device (the electrostatic coating device 1) of this embodiment, since the mixing of the first liquid agent (the main agent L1) and the second liquid agent (the curing agent L2) to be supplied to the rotary atomizing head (the rotary atomizing head 22) can be promoted, the mixing properties of the first liquid agent (the main agent L1) and the second liquid agent (the curing agent L2) can be improved. Further, since a contact surface between the first liquid agent (the main agent L1) and the second liquid agent (the curing agent L2) in the mixed liquid agent is set to be large (a length of a contact part in a cross-section is set to be long), the mixing properties of the first liquid agent (the main agent L1) and the second liquid agent (the curing agent L2) can be further improved. Further, since the mixing properties are improved, a high-viscosity liquid agent can be used. Accordingly, the coping ability of the coating device (the electrostatic coating device 1) can be improved.

Further, the coating device (the electrostatic coating device 1) of this embodiment further includes the mixing member (the mixing member 165) that is disposed inside the liquid mixture supply pipe, includes a plurality of torsion elements, and further mixes the mixed liquid agent (the paint P) flowing in the liquid mixture supply pipe.

According to the coating device (the electrostatic coating device 1) of this embodiment, since the mixed liquid agent (the paint P) of which a contact surface between the first liquid agent (the main agent L1) and the second liquid agent (the curing agent L2) increases (a length of a contact part in a cross-section increases) is further mixed (stirred) by the mixing member (the mixing member 165), the mixing properties can be further improved. Further, since the mixed liquid agent (the paint P) of which a contact surface between the first liquid agent (the main agent L1) and the second liquid agent (the curing agent L2) increases (a length of a contact part in a cross-section increases) is further mixed (stirred) by the mixing member (the mixing member 165), the length of the mixing member can be shortened (the number of elements can be decreased) while maintaining predetermined mixing properties. For example, compared to a case in which the mixing part (the first mixing part) is not used, the length of the mixing member (the number of elements) can be shortened (decreased) by about 25%. Accordingly, since the length of the mixing member (the number of elements) can be shortened (decreased) by about 25%, the supply pipe 11 can be decreased in size. Further, since the length of the mixing member (the number of elements) can be shortened (decreased) by about 25%, the coating device (the electrostatic coating device 1) can improve the internal cleaning performance.

Further, a coating method of this embodiment includes: a first supply step of supplying the first liquid agent (the main agent L1); a second supply step of supplying the second liquid agent (the curing agent L2); a first mixing step corresponding to a mixing step of mixing the first liquid agent and the second liquid agent so that the second liquid agent surrounds the outer periphery of the first liquid agent to be merged with the first liquid agent; a liquid mixture supply step of supplying the mixed liquid agent obtained by the first mixing step to the rotary atomizing head (the rotary atomizing head 22); and a rotary atomization step of charging and atomizing the mixed liquid agent by the rotary atomizing head.

According to the coating method of this embodiment, since the mixing of the first liquid agent (the main agent L1) and the second liquid agent (the curing agent L2) to be supplied to the rotary atomizing head (the rotary atomizing head 22) can be promoted, the mixing properties of the first liquid agent (the main agent L1) and the second liquid agent (the curing agent L2) can be improved. Further, since a contact surface between the first liquid agent (the main agent L1) and the second liquid agent (the curing agent L2) in the liquid mixture can be set to be large (a length of a contact part in a cross-section can be set to be long), the mixing properties of the first liquid agent (the main agent L1) and the second liquid agent (the curing agent L2) can be improved.

Further, in the coating method of this embodiment, the liquid mixture supply step further includes a second mixing step of further mixing the mixed liquid agent (the paint P) by the mixing member (the mixing member 165) including the plurality of torsion elements.

According to this embodiment, since the mixed liquid agent (the paint P) of which a contact surface between the first liquid agent (the main agent L1) and the second liquid agent (the curing agent L2) increases (a length of a contact part in a cross-section increases) is further mixed (stirred) by the mixing member (the mixing member 165), the mixing properties can be further improved. Further, since the mixed liquid agent (the paint P) of which a contact surface between the first liquid agent (the main agent L1) and the second liquid agent (the curing agent L2) increases (a length of a contact part in a cross-section is set to be long) is further mixed (stirred) by the mixing member (the mixing member 165), the length of the mixing member can be shortened (the number of elements can be decreased) while maintaining predetermined mixing properties. For example, compared to a case in which the mixing part (the first mixing part) is not used, for example, the length of the mixing member (the number of elements) can be shortened (decreased) by about 25%. Accordingly, since the length of the mixing member (the number of elements) can be shortened (decreased) by about 25%, the size of the coating device in use can be decreased. Further, since the length of the mixing member (the number of elements) can be shortened (decreased) by about 25%, the internal cleaning performance of the coating device in use can be improved.

The invention is not limited to the above-described embodiment and modifications, improvements, and the like within the scope capable of attaining the object of the invention are included in the invention. Further, in this embodiment, the electrostatic coating device includes the mixing member disposed on the downstream side of the first mixing part, but the invention is not limited thereto. The mixing member may not be provided. In this case, in the electrostatic coating device, the mixed liquid agent (the paint P) obtained by mixing the main agent and the curing agent at the first mixing part is supplied to the rotary atomizing head. Then, also in this case, the electrostatic coating device has a mixing property higher than that of the conventional electrostatic coating device without the mixing member and can coat a further mixed paint to a coating target.

Further, in this embodiment, the electrostatic coating device has a configuration in which the first supply pipe supplies the main agent and the second supply pipe supplies the curing agent, but the invention is not limited thereto. The first supply pipe may supply the curing agent and the second supply agent may supply the main agent.

### EXPLANATION OF REFERENCE NUMERALS

1 ELECTROSTATIC COATING DEVICE (COATING DEVICE)
22 ROTARY ATOMIZING HEAD
11 SUPPLY PIPE
130 FIRST SUPPLY PIPE
140 SECOND SUPPLY PIPE
150 FIRST MIXING PART
151 OUTER PIPE PART
152 MERGING PART
160 LIQUID MIXTURE SUPPLY PIPE
161 SECOND MIXING PART
165 MIXING MEMBER
162 NOZZLE PART
L1 MAIN AGENT (FIRST LIQUID AGENT)
L2 CURING AGENT (SECOND MAIN AGENT)
P PAINT (MIXED LIQUID AGENT)
X ROTATION AXIS

1. A coating device comprising:
a rotary atomizing head which rotates about a rotation axis while being applied with a high voltage to charge and atomize a mixed liquid agent including at least a first liquid agent and a second liquid agent;
a first supply pipe which supplies the first liquid agent;
a second supply pipe which supplies the second liquid agent;
a mixing part which merges the first supply pipe to be coaxial to the rotation axis and merges the second supply pipe to be inclined with respect to the rotation axis so that the first liquid agent and the second liquid agent are mixed; and
a liquid mixture supply pipe which is disposed between the mixing part and the rotary atomizing head and supplies the mixed liquid agent to the rotary atomizing head,
wherein the mixing part includes:
an outer pipe part which is formed to surround an outer periphery of an end part on the side of the liquid mixture supply pipe of the first supply pipe and is connected to the second supply pipe, and
a merging part which is formed in a vicinity of the end part of the first supply pipe and merges the first liquid agent with the second liquid agent so that the second liquid agent supplied from the outer pipe part surrounds an outer periphery of the first liquid agent supplied from the first supply pipe.

2. The coating device according to claim 1 further comprising:
a mixing member that is disposed inside the liquid mixture supply pipe, includes a plurality of torsion elements, and further mixes the mixed liquid agent flowing in the liquid mixture supply pipe.

3. A coating method comprising:
a first supply step of supplying a first liquid agent;
a second supply step of supplying a second liquid agent;
a first mixing step corresponding to a mixing step of mixing the first liquid agent with the second liquid agent so that the second liquid agent surrounds an outer periphery of the first liquid agent to be merged with the first liquid agent;
a liquid mixture supply step of supplying a mixed liquid agent obtained by the first mixing step to a rotary atomizing head rotating about a rotation axis; and
a rotary atomization step of charging and atomizing the mixed liquid agent by the rotary atomizing head,
wherein the first mixing step merges the first liquid agent to be coaxial to the rotation axis and merges the second liquid agent to be inclined with respect to the rotation axis.

4. The coating method according to claim 3,
wherein the liquid mixture supply step further includes a second mixing step of further mixing the mixed liquid agent by a mixing member including a plurality of torsion elements.
